(19) United States
(12) Patent Application Publication
(10) Pub. No.: US 2016/0039251 A1
(43) Pub. Date: Feb. 11, 2016

(54) Tire Assembly

(71) Applicant: Manar Ashak, Richmond Hill (CA)

(72) Inventor: Manar Ashak, Richmond Hill (CA)

(21) Appl. No.: 14/451,560

(22) Filed: Aug. 5, 2014

(51) Int. Cl. B60C 13/02; B60C 13/00

(52) U.S. Cl. CPC B60C 13/02; B60C 13/003

(57) ABSTRACT

A tire assembly includes a tire. The tire has a pair of perimeter walls coupled to and extending inwardly from an outer wall of the tire. The pair of perimeter walls of the tire each has a distal edge with respect to the outer wall of the tire. The distal edge of each of the pair of perimeter walls of the tire defines an opening. The tire may be coupled to a wheel on a vehicle. The tire is one of a pair of the tires each positioned adjacent to one another. A ring is coupled to and extends outwardly from an associated one of the pair of perimeter walls of the tire. The pair of tires is oriented so the ring on each of the pair of tires is directed toward one another. The ring deflects an object outwardly from between the pair of tires.

### BACKGROUND OF THE DISCLOSURE

### Field of the Disclosure

The disclosure relates to tire devices and more particularly pertains to a new tire device for preventing an object from becoming lodged between a pair of tires on a vehicle.

### SUMMARY OF THE DISCLOSURE

An embodiment of the disclosure meets the needs presented above by generally comprising a tire. The tire has a pair of perimeter walls coupled to and extending inwardly from an outer wall of the tire. The pair of perimeter walls of the tire each has a distal edge with respect to the outer wall of the tire. The distal edge of each of the pair of perimeter walls of the tire defines an opening. The tire may be coupled to a wheel on a vehicle. The tire is one of a pair of the tires each positioned adjacent to one another. A ring is coupled to and extends outwardly from an associated one of the pair of perimeter walls of the tire. The pair of tires is oriented so the ring on each of the pair of tires is directed toward one another. The ring deflects an object outwardly from between the pair of tires.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a tire assembly according to an embodiment of the disclosure.

FIG. 2 is a right side view of an embodiment of the disclosure.

FIG. 3 is a front view of an embodiment of the disclosure.

FIG. 4 is a cross sectional view taken along line 4-4 of FIG. 2 of an embodiment of the disclosure.

FIG. 5 is an in-use view of an embodiment of the disclosure.

FIG. 6 is a schematic view of a method of utilizing an embodiment of the disclosure.

### DESCRIPTION OF THE PREFERRED EMBODIMENT

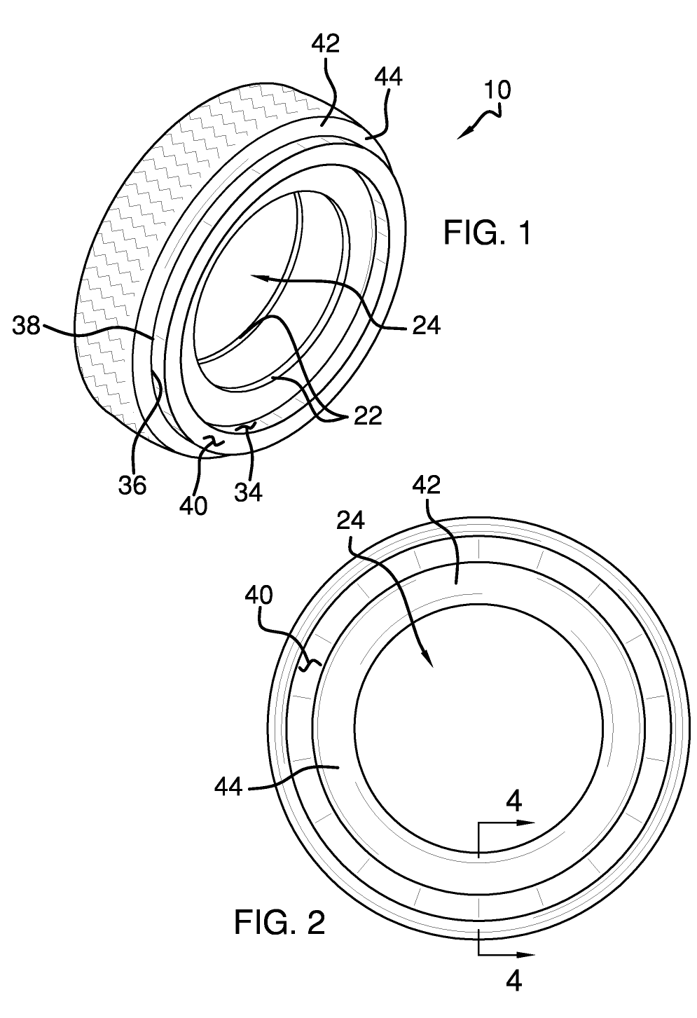

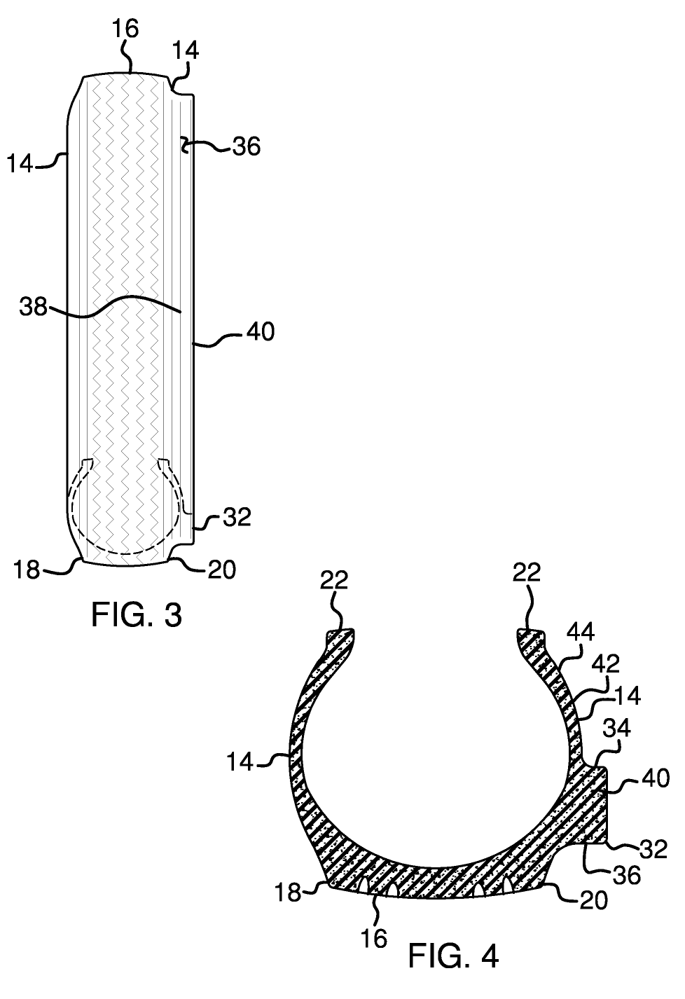

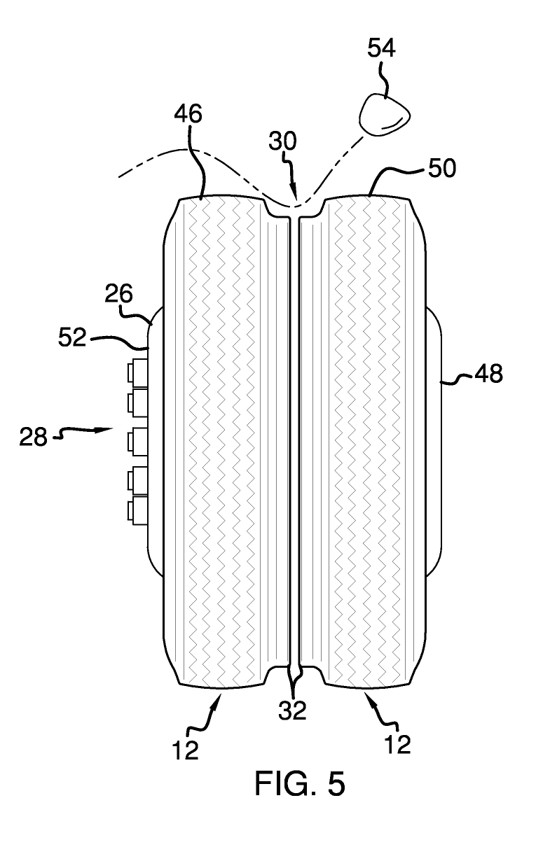

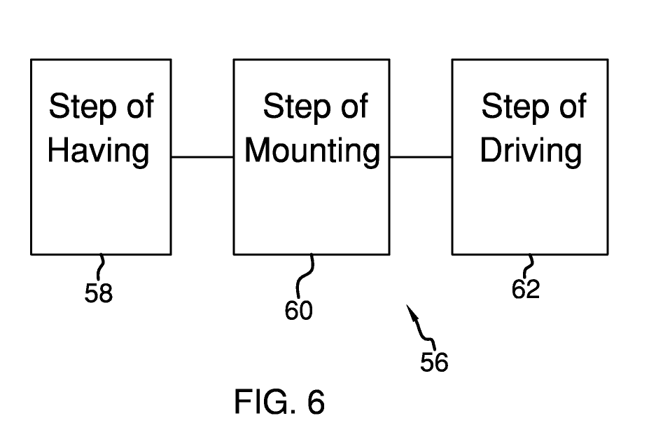

With reference now to the drawings, and in particular to FIGS. 1 through 6 thereof, a new tire device embodying the principles and concepts of an embodiment of the disclosure and generally designated by the reference numeral 10 will be described.

As best illustrated in FIGS. 1 through 6, the tire assembly 10 generally comprises a wheel 26. The wheel 26 may be coupled to a vehicle 28. The vehicle 28 may be a truck of any conventional design. Finally, the wheel 26 may be a dual wheel of any conventional design.

A pair of tires 12 is provided. The tires 12 have a pair of perimeter walls 14 coupled to and extending inwardly from an outer wall 16 of the tires 12. The outer wall 16 of the tires 12 has a first oblique side 18 and a second oblique side 20. The pair of perimeter walls 14 of the tires 12 is each positioned adjacent to an associated one of the first 18 and second 20 oblique sides of the outer wall 16 of the tires 12.

The pair of perimeter walls 14 of the tires 12 each has a distal edge 22 with respect to the outer wall 16 of the tires 12. The distal edge 22 of the pair of perimeter walls 14 of the tires 12 defines an opening 24. The tires 24 may be removably coupled to the wheel 26 on the vehicle 28. Moreover, the tires 24 are adjacently positioned defining a gap 30 between the tires 12.

A pair of rings 32 is provided. The rings 32 have an inner surface 34 and an outer surface 36 each extending between a first lateral surface 38 and a second lateral surface 40 of the rings 32. The inner 34 and outer 36 surfaces of the rings 32 are curvilinear with respect to each other. The rings 32 forms a closed loop.

The first lateral surface 38 of the rings 32 are coupled to an outermost side 42 of a first one 44 of the pair of perimeter walls 14 of the tires 12. The outer surface 36 of the ring 32 is positioned closer to the outer wall 16 of the tires 12 than the distal edge 22 of the first perimeter wall 44 of the tires 12. The rings 32 extends outwardly from the first perimeter wall 44 of the tires 12.

An outer one 46 of the tires 12 is positioned on the wheel 26. An associated one of the pair of rings 32 on the outer tire 46 is directed inwardly toward an interior side 48 of the wheel 26. An inner one 50 of the pair of tires 30 is positioned on the wheel 26 so an associated one of the pair of rings 32 on the inner tire 50 is directed outwardly toward an exterior side 52 of the wheel 26. The rings 32 on each of the pair of tires 30 is directed toward one another. The rings 32 on each of each of the pair of tires 30 deflects an object 54 outwardly from between the pair of tires 30.

In use, a method 56 of preventing the object 54 from becoming lodged between the pair of tires 30 includes the steps of having 58 the pair of tires 30 with the ring 32 coupled thereto. Mounting 60 the pair of tires 30 on the wheel 26 on the vehicle 28 so the ring 32 on each of the pair of tires 30 faces each other. Driving 62 the vehicle 28 so the ring 32 on each of the pair of tires 30 deflects the object 54 away from between the pair of tires 30.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A tire assembly comprising:
a wheel;
a pair of tires, each said tires being coupled to said wheel such that said tires are adjacently positioned defining a gap between said tires; and
a pair of rings, each of said rings being coupled to and extending outwardly from an associated one of said tires, said rings being aligned and positioned in said gap between said tires wherein said rings are configured for inhibiting an object from entering said gap between said tires.

2. The assembly according to claim 1, further comprising said tires each having a pair of perimeter walls coupled to and extending inwardly from an outer wall of said tires, said pair of perimeter walls of said tires each having a distal edge with respect to said outer wall of said tires, said distal edge of each of said pair of perimeter walls of said tires defining an opening such that said tires are configured to be coupled to said wheel.

3. The tire assembly according to claim 2, further comprising said outer wall of said tires having a first oblique side and a second oblique side, said pair of perimeter walls of said tires each being positioned adjacent to an associated one of said first and second oblique sides of said outer wall of said tires.

4. The tire assembly according to claim 1, further comprising said rings each having an inner surface and an outer surface each extending between a first lateral surface and a second lateral surface of said rings.

5. The assembly according to claim 4, further comprising said inner and outer surfaces of said rings being curvilinear with respect to each other such that said rings each forms a closed loop.

6. The tire assembly according to claim 5, further comprising a pair of perimeter walls of said tires each having an outermost side and an innermost side, said first lateral surface of said rings being coupled to said outermost side of a first one of said pair of perimeter walls of an associated one of said tires such that said outer surface of said rings is positioned closer to said outer wall of said tires than said distal edge of said first perimeter wall of said tires.

7. The tire assembly according to claim 1, further comprising an outer one of said pair of tires being positioned on the wheel such that an associated one of said pair of rings on said outer tire is directed inwardly toward an interior side of said wheel.

8. The tire assembly according to claim 1, further comprising an inner one of said pair of tires being positioned on the wheel such that an associated one of said pair of rings on said inner tire is directed outwardly toward an exterior side of said wheel.

9. A tire assembly configured to prevent an object from becoming lodged between a pair of said tires on a vehicle, said assembly comprising:
a wheel;
a pair of tires, said tires each having a pair of perimeter walls coupled to and extending inwardly from an outer wall of said tires, said pair of perimeter walls of said tires each having a distal edge with respect to said outer wall of said tires, said outer wall of said tires having a first oblique side and a second oblique side, said pair of perimeter walls of said tires each being positioned adjacent to an associated one of said first and second oblique sides of said outer wall of said tires;
said distal edge of each of said pair of perimeter walls of said tires defining an opening such that said tires are configured to be coupled to said wheel having said tires being adjacently positioned defining a gap between said tires; and
a pair of rings, said rings each having an inner surface and an outer surface each extending between a first lateral surface and a second lateral surface of said rings, said inner and outer surfaces of said rings being curvilinear with respect to each other such that said rings each forms a closed loop;
said first lateral surface of said rings being coupled to said outermost side of a first one of said pair of perimeter walls of an associated one of said tires such that said outer surface of said rings is positioned closer to said outer wall of said tires than said distal edge of said first perimeter wall of said tires;
an outer one of said pair of tires being positioned on the wheel such that an associated one of said pair of rings on said outer tire is directed inwardly toward an interior side of said wheel;
an inner one of said pair of tires being positioned on the wheel such that an associated one of said pair of rings on said inner tire is directed outwardly toward an exterior side of said wheel, said rings being aligned and positioned in said gap between said tires wherein said rings are configured for inhibiting an object from entering said gap between said tires.

10. A method of preventing an object from becoming lodged between a pair of tires, the steps of the method comprising:
having a pair of tires having a ring coupled thereto;
mounting said pair of tires on a wheel on a vehicle such that said ring on each of said pair of tires faces each other; and
driving the vehicle such that said ring on each of said pair of tires deflects an object away from between said pair of tires.
